(19) United States
(12) Patent Application Publication
(10) Pub. No.: US 2025/0267584 A1
(43) Pub. Date: Aug. 21, 2025

(54) SYSTEMS AND METHODS FOR CONTROLLING A SMART NODE ON/OFF STATE

(71) Applicant: ZTE CORPORATION, Shenzhen (CN)

(72) Inventors: Hanqing XU, Shenzhen (CN); Nan ZHANG, Shenzhen (CN); Ziyang LI, Shenzhen (CN); Wei CAO, Shenzhen (CN); Shuang ZHENG, Shenzhen (CN)

(73) Assignee: ZTE CORPORATION, Shenzhen (CN)

(21) Appl. No.: 19/197,317

(22) Filed: May 2, 2025

Related U.S. Application Data
(63) Continuation of application No. PCT/CN2023/091509, filed on Apr. 28, 2023.

(51) Int. Cl. H04W 52/02; H04L 5/14; H04W 72/044

(52) U.S. Cl. CPC H04W 52/0235; H04L 5/14; H04W 72/044

(57) ABSTRACT

Presented are systems and methods for controlling a smart node ON/OFF state. A network node (e.g., smart node (SN)) may receive, from a wireless communication node (e.g., base station (BS) or gNB), at least one of: a first message indicating first time-domain and/or frequency-domain (T/F) resources; or a second message indicating a plurality of second T/F resources. The network node may determine to: (i) turn on a forwarding entity of the network node in at least one of: the first T/F resources; one or more of the plurality of second T/F resources; or one or more of a plurality of third T/F resources; and/or (ii) turn off the forwarding entity in at least one of: fourth T/F resources; one or more of the plurality of third T/F resources; or one or more of a plurality of fifth T/F resources.

### CROSS-REFERENCE TO RELATED APPLICATION

This application claims the benefit of priority under 35 U.S.C. § 120 as a continuation of PCT Patent Application No. PCT/CN2023/091509, filed on Apr. 28, 2023, the disclosure of which is incorporated herein by reference in its entirety.

### TECHNICAL FIELD

The disclosure relates generally to wireless communications, including but not limited to systems and methods for controlling a smart node ON/OFF state.

### BACKGROUND

Coverage is a fundamental aspect of cellular network deployments. Mobile operators rely on different types of network nodes to offer blanket coverage in their deployments. As a result, new types of network nodes have been considered to increase the flexibility of mobile operators for their network deployments. For example, certain systems or architecture introduce integrated access and backhaul (IAB), which may be enhanced in certain other systems, as a new type of network node not requiring a wired backhaul. Another type of network node is the RF repeater which simply amplify-and-forward any signal that they receive. RF repeaters have seen a wide range of deployments in 2G, 3G and 4G to supplement the coverage provided by regular full-stack cells.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium. A network node (e.g., smart node (SN)) may receive, from a wireless communication node (e.g., base station (BS) or gNB), at least one of: a first message indicating first time-domain and/or frequency-domain (T/F) resources; or a second message indicating a plurality of second T/F resources. The network node may determine to: (i) turn on a forwarding entity of the network node in at least one of: the first T/F resources; one or more of the plurality of second T/F resources; or one or more of a plurality of third T/F resources; and/or (ii) turn off the forwarding entity in at least one of: fourth T/F resources; one or more of the plurality of third T/F resources; or one or more of a plurality of fifth T/F resources. The third T/F resources can be determined based on the first T/F resources, the second T/F resources, and/or the fourth T/F resources. The fourth T/F resources can be determined based on the first T/F resources, or indicated via the first message. The fifth T/F resources can be determined based on the second T/F resources.

In some embodiments, the step of turning on the forwarding entity may further comprise causing the forwarding entity to forward, transmit, and/or receive only in the first T/F resources, only in the one or more second T/F resources, and/or only in the one or more third T/F resources. The first T/F resources may include at least one of: a. DL time units; b. UL time units; c. flexible time units; d. time units with frequency bands in a frequency domain; e. DL time units with frequency bands in a frequency domain; f. UL time units with frequency bands in a frequency domain; g. flexible time units with frequency bands in a frequency domain; h. time units without frequency bands in a frequency domain; i. DL time units without frequency bands in a frequency domain; j. UL time units without frequency bands in a frequency domain; k. flexible time units without frequency bands in a frequency domain; l. frequency bands; m. frequency bands in DL time units; n. frequency bands in UL time units; o. frequency bands in flexible time units; p. T/F resources outside of frequency bands; q. T/F resources outside of frequency bands in DL time units; r. T/F resources outside of frequency bands in UL time units; or s. T/F resources outside of frequency bands in flexible time units. The second T/F resources can be configured for the forwarding entity to forward, transmit and/or receive. The second T/F resources can be associated with beams indicated in the second message. The second T/F resources and/or the beams can be valid.

In some embodiments, the step of turning off the forwarding entity may further comprise causing the forwarding entity not to forward, transmit and/or receive in the fourth T/F resources, in the one or more third T/F resources, and/or in the one or more fifth T/F resources. The fourth T/F resources may include resources beyond the first T/F resources, or at least one of: a. DL time units; b. UL time units; c. flexible time units; d. time units with frequency bands in a frequency domain; c. DL time units with frequency bands in a frequency domain; f. UL time units with frequency bands in a frequency domain; g. flexible time units with frequency bands in a frequency domain; h. time units without frequency bands in a frequency domain; i. DL time units without frequency bands in a frequency domain; j. UL time units without frequency bands in a frequency domain; k. flexible time units without frequency bands in a frequency domain; l. frequency bands; m. frequency bands in DL time units; n. frequency bands in UL time units; o. frequency bands in flexible time units; p. T/F resources outside of frequency bands; q. T/F resources outside of frequency bands in DL time units; r. T/F resources outside of frequency bands in UL time units; or s. T/F resources outside of frequency bands in flexible time units.

In some embodiments, the fifth T/F resources may include resources beyond the second T/F resources. The second T/F resources may not overlap with or may not include the fourth T/F resources, or the second T/F resources may belong to the first T/F resources. The third T/F resources may include resources that overlap between the fourth T/F resources and the second T/F resources, or resources that are in the second T/F resources but are not in the first T/F resources, or resources that are in the first T/F resources but are not in the second T/F resources.

In some embodiments, the network node may receive, from the wireless communication node, the second message including an indication for the forwarding entity to transmit and/or receive. The network node may determine to turn on the forwarding unit in the third T/F resources if the indication meets at least one of: (a) the indication being periodic; (b) the indication being semi-persistent; (c) the indication being aperiodic; (d) the indication with a priority flag; or (e) time-domain resource(s) and/or beam index(es) in the indication being valid. The network node may determine to turn off the forwarding unit, in response to the indication of the second message does not meet any of the conditions (a) to (e). The time unit can be a symbol, a slot, a subframe, or a frame. The frequency band may include at least one of: a subband, a set of resource block, a group of resource block, a channel, a sub-channel, a carrier, a carrier group, a passband, a frequency resource, a frequency range, an operating band, a cell, a bandwidth part, or a band of frequency spectrum. The frequency band can be a frequency band with DL or UL direction, an active or inactive frequency band, or a frequency band whose TDD configuration is indicated or not indicated to the network node. The first message and/or the second message can include at least one of: one or more system information, one or more a RRC signalings, one or more a MAC CEs, one or more DCI signalings, or a combination thereof.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with some embodiments of the present disclosure of the present disclosure;

FIG. 2 illustrates a block diagram of an example base station and a user equipment device, in accordance with some embodiments of the present disclosure;

FIG. 3 illustrates a schematic diagram of transmission links between BS to SN and SN to UE, in accordance with some embodiments of the present disclosure;

FIG. 4 illustrates a framework diagram of an example method for controlling a smart node ON/OFF state, in accordance with some embodiments of the present disclosure;

FIG. 5 illustrates an example method for controlling a smart node ON/OFF state, in accordance with some embodiments of the present disclosure;

FIG. 6 illustrates an example method for controlling a smart node ON/OFF state, in accordance with some embodiments of the present disclosure;

FIG. 7 illustrates an example method for controlling a smart node ON/OFF state, in accordance with some embodiments of the present disclosure;

FIG. 8 illustrates an example method for controlling a smart node ON/OFF state, in accordance with some embodiments of the present disclosure;

FIG. 9 illustrates an example method for controlling a smart node ON/OFF state, in accordance with some embodiments of the present disclosure;

FIG. 10 illustrates an example method for controlling a smart node ON/OFF state, in accordance with some embodiments of the present disclosure;

FIG. 11 illustrates an example method for controlling a smart node ON/OFF state, in accordance with some embodiments of the present disclosure;

FIG. 12 illustrates an example method for controlling a smart node ON/OFF state, in accordance with some embodiments of the present disclosure; and

FIG. 13 illustrates a flow diagram of an example method for controlling a smart node ON/OFF state, in accordance with some embodiments of the present disclosure.

### DETAILED DESCRIPTION

### 1. Mobile Communication Technology and Environment

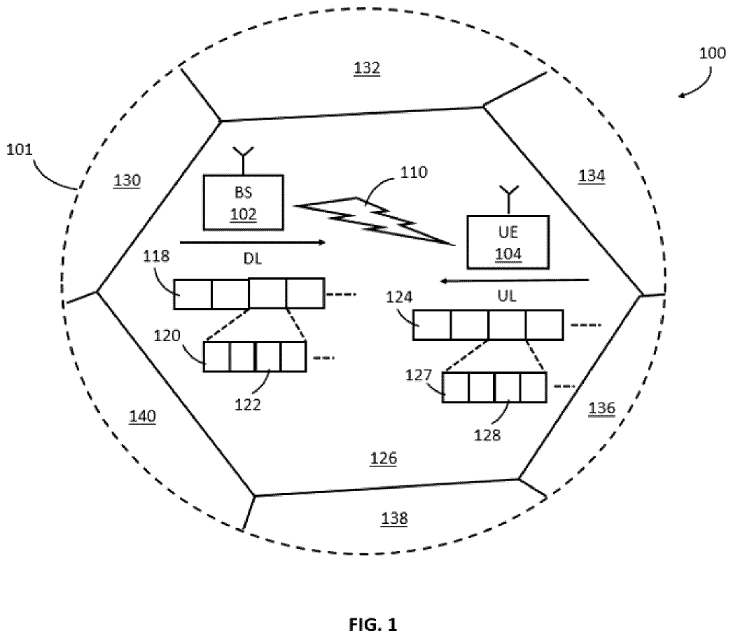

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

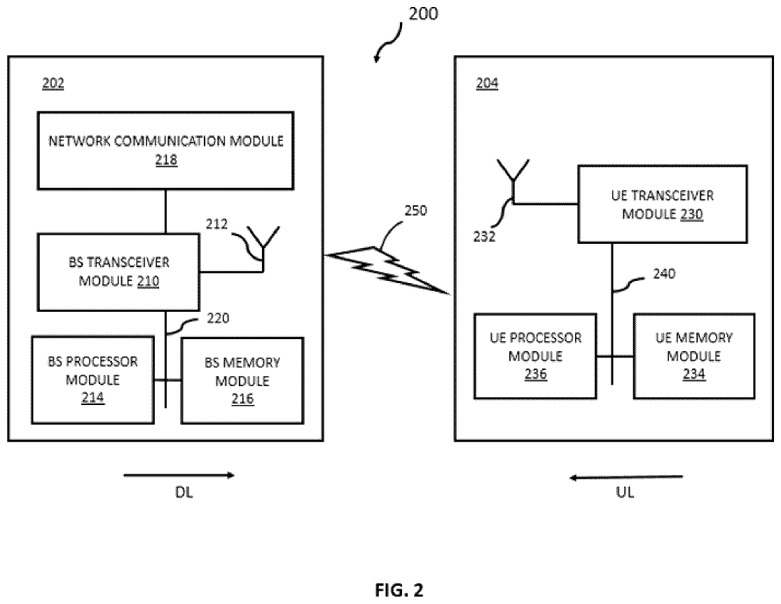

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuity that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for Controlling a Smart Node ON/OFF State

In certain systems (e.g., 5G new radio (NR), Next Generation (NG) systems, 3GPP systems, and/or other systems), a network-controlled repeater (NCR) can be introduced as an enhancement over conventional radio frequency (RF) repeaters with the capability to receive and/or process side control information from the network. As discussed herein, network nodes, including and not limited to network-controlled repeater, smart repeater, Re-configuration intelligent surface (RIS), Integrated Access and Backhaul (IAB), can be denoted as a smart node (SN) (e.g., network node) for simplicity. For example, the SN can include, correspond to, or refer to a kind of network node to assist the BS 102 to improve coverage (e.g., avoiding/averting blockage/obstructions, increasing transmission range, etc.).

When a SN is not utlized, the SN can be turned to a OFF state to save power

consumption and reduce interference to nearby devices (e.g., neighboring UEs/BSs/SNs). When a SN is utilized to improve coverage and increase system capacity, the SN can be turned to a ON state again. In order to more smoothly turn SN ON/OFF according to actual demands or explicit/implicit indication, a method of ON/OFF state control can be performed.

Coverage can be a fundamental aspect of cellular network deployments. Mobile operators may rely on different types of network nodes to offer blanket coverage in their deployments. Therefore, new types of network nodes have been considered to increase mobile operators' flexibility for their network deployments. For example, Integrated Access and Backhaul (IAB) was introduced as a new type of network node not requiring a wired backhaul. Another type of network node can be the RF repeater which simply amplify-and-forward any signal that it receives. RF repeaters have seen a wide range of deployments in 2G, 3G and 4G to supplement the coverage provided by regular full-stack cells. A RF repeater may have a radio unit.

A network-controlled repeater can be introduced as an enhancement over conventional RF repeaters with the capability to receive and process side control information from the network. Side control information may allow a network-controlled repeater to perform its amplify-and-forward operation in a more efficient manner. Potential benefits includes mitigation of unnecessary noise amplification, transmissions and receptions with better spatial directivity, and simplified network integration. Same mechanism for controlling specified in this disclosure can also be applied to other systems including Re-configuration intelligent surface (RIS).

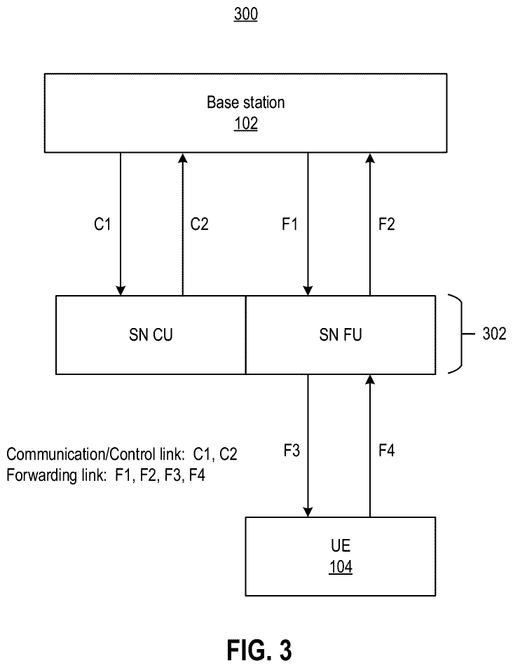

FIG. 3 illustrates a schematic diagram 300 of transmission links between BS 102 to SN 302 and SN 302 to UE 104. The SN 302 can include or consist of at least two functional parts/components/units (e.g., function entities), such as the communication unit (CU) (e.g., SN CU, sometimes referred to as a first function entity or unit)) and the forwarding unit (FU) (e.g., SN FU, sometimes referred to as a second function entity or unit). The function entities can support different functions. For example, the SN CU can be a network-controlled repeater (NCR) MT. In another example, the SN FU can be an NCR forwarder/forwarding (Fwd). The SN CU can act/behave or include features similar to a UE 104, for instance, to receive and decode side control information from the BS 102. The SN CU may be a control unit, controller, mobile terminal (MT), part of a UE, a third-party IoT device, and so on. The SN FU can carry out the intelligent amplify-and-forward operation using the side control information received by the SN CU. The SN FU may be a radio unit (RU), a RIS, and so on. For simplicity, CU (e.g., SN CU) and FU (e.g., SN FU) can correspond to or refer to the first unit and the second unit, respectively.

The transmission links between the BS 102 to SN 302 and the SN 302 to UE 104 as shown in FIG. 3 can be defined/described/provided as follows:
C1: Control link (e.g., C-link or first control link) from BS to SN CU;
C2: Control link (e.g., C-link or second control link) from SN CU to BS;
F1: Forwarding link (e.g., F-link or first forwarding link, which in this case can be a backhaul link) from BS to SN FU;
F2: (e.g., F-link or second forwarding link, which in this case can be a backhaul link) from SN FU to BS;
F3: (e.g., F-link or third forwarding link, which in this case can be an access link) from SN FU to UE; and
F4: (e.g., F-link or fourth forwarding link, which in this case can be an access link) from UE to SN FU.

Control link (e.g., sometimes referred to as a communication link) can refer to or mean that the signal from one side will be detected and decoded by the other side, so that the information transmitting in the control link can be utilized to control the status of forwarding links (e.g., backhaul links and/or access links). Forwarding link can mean that the signal from BS 102 or UE 104 is unknown to SN FU. In this case, the SN FU can amplify and forward signals without decoding them. For example, the F2 and F4 links can correspond to or be associated with the complete uplink (UL) forwarding link (e.g., backhaul link and access link, respectively) from UE 104 to BS 102, in which F2 is the SN FU UL forwarding link. Additionally, the F1 and F3 links can correspond to or be associated with the complete DL forwarding link (e.g., backhaul link and access link, respectively) from BS 102 to UE 104, in which F3 is the SN FU DL forwarding link. The F1 and F2 links can correspond to or be referred to as backhaul links (B-link) and F3 and F4 links can correspond to or be referred to as access links (A-link). Backhaul link and access link can be part of forwarding link, and the combination of the two may constitute a complete forwarding link.

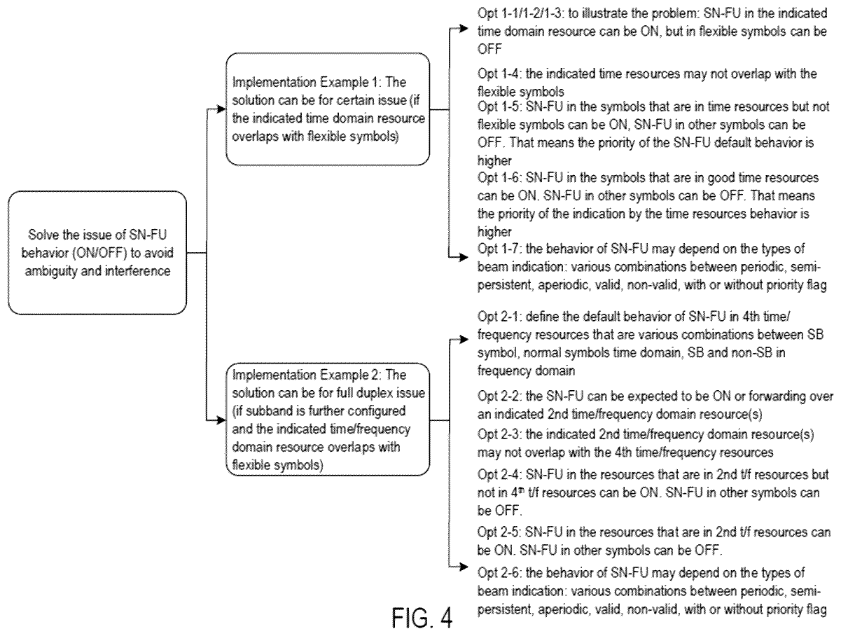

FIG. 4 illustrates a framework diagram of an example method for controlling a smart node ON/OFF state, in accordance with an embodiment of the present disclosure. When a SN is not utilized, the SN can be turned to a OFF state to save power consumption and to reduce interference to nearby devices (e.g. neighboring UEs/BSs/SNs). When a SN is utilized to improve coverage and increase system capacity, the SN can be turned to a ON state again. In order to more smoothly turn SN ON/OFF, the present disclosure provides a method of SN (e.g., SN-FU) ON/OFF state control in flexible and other time units (e.g., symbols).

SN OFF in a time/frequency/spatial/link resource may indicate/mean that SN does not forward, transmit and/or receive in the time/frequency/spatial/link resource, or SN forwards, transmits and/or receives only in other resources other than the above time/frequency/spatial/link resource.

SN ON in a time/frequency/spatial/link resource may indicate/mean that SN forwards, transmits and/or receives (only) in the time/frequency/spatial/link resource, or SN does not forward, transmit and/or receive in other resources other than the above time/frequency/spatial/link resource.

### IMPLEMENTATION EXAMPLE 1

### Indicated Time Domain Resource May Overlap With Flexible Symbols

For SN-FU ON/OFF (e.g., forwarding/not-forwarding the receptions from the base station (or the UE) to the UE (or the base station)), several options can be considered as follows. These options can be implemented individually or in combination with each other.

Opt 1-1 (option 1-1): For the flexible symbols based on the semi-static configuration (e.g., TDD-UL-DL-ConfigCommon, and/or TDD-UL-DL-ConfigDedicated), a default behavior of the SN-FU can be expected to be OFF or not forwarding over these symbols.

Opt 1-2 (option 1-2): For the flexible symbols based on the semi-static configuration (e.g., TDD-UL-DL-ConfigCommon, and/or TDD-UL-DL-ConfigDedicated) and dynamic UL-DL indication (e.g., a SFI signaling, a new dynamic UL-DL signaling or a scheduling signaling with explicit/implicit indication), a default behavior of the SN-FU can be expected to be OFF or not forwarding over these symbols.

Opt 1-3 (option 1-3): For the symbols in an indicated time domain resource(s), the SN-FU can be expected to be ON or forwarding over these symbols. Further, one or more of the following points can be performed in Opt 1-3.
The indicated time domain resource(s) can be associated with corresponding beam(s) in the forwarding link beam indication.
The forwarding link beam indication can be indicated to SN (SN-CU) by the base station for SN (SN-FU) forwarding.
The forwarding link beam indication can be access link beam indication and/or backhaul link beam indication.
The forwarding link beam indication may include beam information (e.g., beam index(es)) and/or the corresponding time domain resource(s).

If taking Opt 1-1 (or Opt 1-2) and Opt 1-3 into account together for controlling SN-FU ON/OFF state, it can be found that the behavior of the SN-FU can be uncertainty if the indicated time domain resource(s) in the forwarding link beam indication overlap with/include the flexible symbols based on the semi-static configuration and/or dynamic UL-DL indication. If the behavior of the SN-FU is uncertainty, the behavior may cause interference and performance loss.

One or more of the following options can solve the above problem. The options in the disclosure including above Opt 1-1/1-2/1-3 can be implemented individually or in combination with each other.

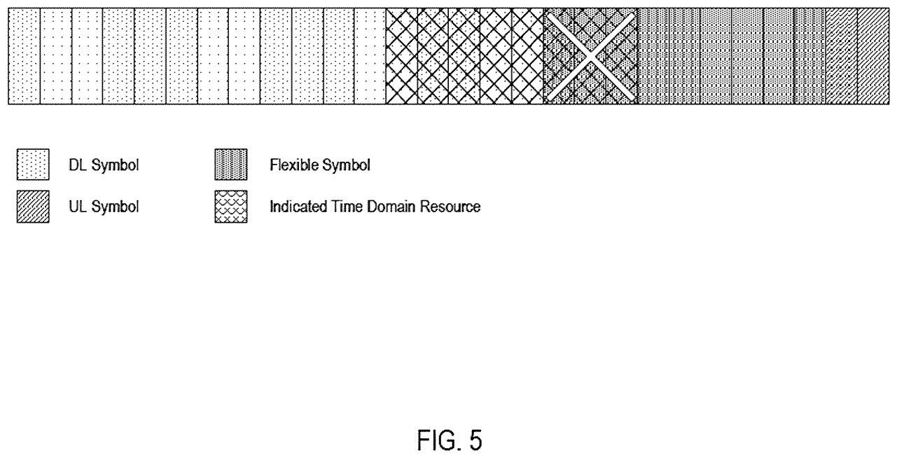

Opt 1-4 (option 1-4): An indicated time domain resource(s) can not overlap-with/include the flexible symbols based on the semi-static configuration and/or dynamic UL-DL indication. FIG. 5 illustrates an example method for controlling a smart node ON/OFF state (e.g., Opt 1-4), in accordance with some embodiments of the present disclosure.

Further, one or more of the following points can be performed in Opt 1-4.
The indicated time domain resource(s) can be associated with corresponding beam(s) in the forwarding link beam indication.
The forwarding link beam indication can be indicated to SN (SN-CU) by the base station for SN (SN-FU) forwarding.
The forwarding link beam indication can be access link beam indication and/or backhaul link beam indication.
The forwarding link beam indication may include beam information (e.g., beam index(es)) and/or the corresponding time domain resource(s).
The indicated time domain resource(s) and/or beam index(es) in the beam indication can be valid.

In other words, the SN (SN-CU/FU) may not be expected that the indicated time domain resource(s) overlap with/include the flexible symbols based on the semi-static configuration and/or dynamic UL-DL indication.

Correspondingly, the base station can not configure the time domain resource(s) that overlap with/include the flexible symbols. With the conditions of Opt 1-4, both Opt 1-1 (or Opt 1-2) and Opt 1-3 can work for solving the issue of SN-FU ON/OFF. In other words, with the conditions of Opt 1-4, for the symbols in an indicated time domain resource(s), the SN-FU can be expected to be ON or forwarding over these symbols. For other symbols, the SN-FU can be expected to be OFF or not forwarding.

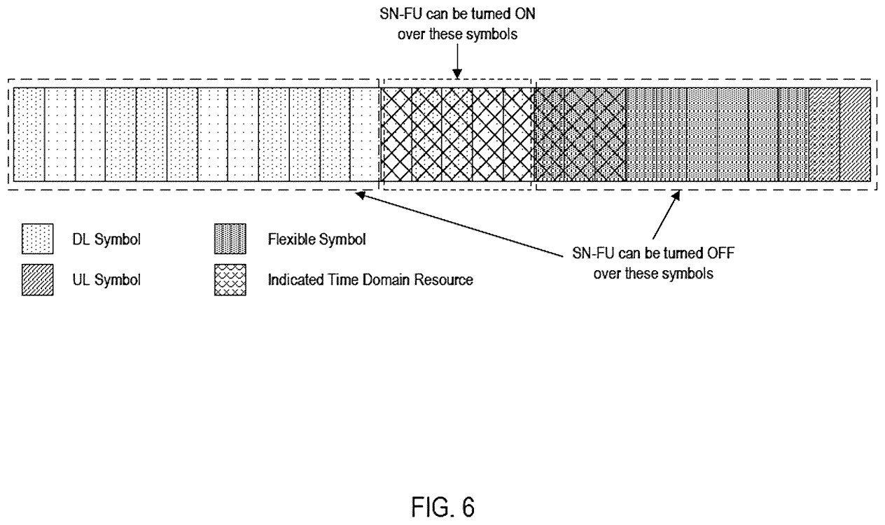

Opt 1-5 (option 1-5): For the symbols that are in an indicated time domain resource(s) and not the flexible symbols based on the semi-static configuration and/or dynamic UL-DL indication, the SN-FU can be expected to be ON or forwarding over these symbols. FIG. 6 illustrates an example method for controlling a smart node ON/OFF state (e.g., Opt 1-5), in accordance with some embodiments of the present disclosure.

Further, one or more of the following points can be performed in Opt 1-5.
The indicated time domain resource(s) can be associated with corresponding beam(s) in the forwarding link beam indication.
The forwarding link beam indication can be indicated to SN (SN-CU) by the base station for SN (SN-FU) forwarding.
The forwarding link beam indication can be access link beam indication and/or backhaul link beam indication.
The forwarding link beam indication may include beam information (e.g. beam index(es)) and/or the corresponding time domain resource(s).
The indicated time domain resource(s) and/or beam index(es) in the beam indication can be valid.
The SN-FU can be expected to be OFF or not forwarding in other symbols (e.g., in the symbols that are in the indicated time domain resource(s) and the flexible symbols, or in the symbols that are not in the indicated time domain resource(s))

In Opt 1-5, for the flexible symbols based on the semi-static configuration and/or dynamic UL-DL indication, regardless of whether the symbols are in the indicated time domain resource(s) or not, the SN-FU can be expected to be OFF or not forwarding over these symbols.

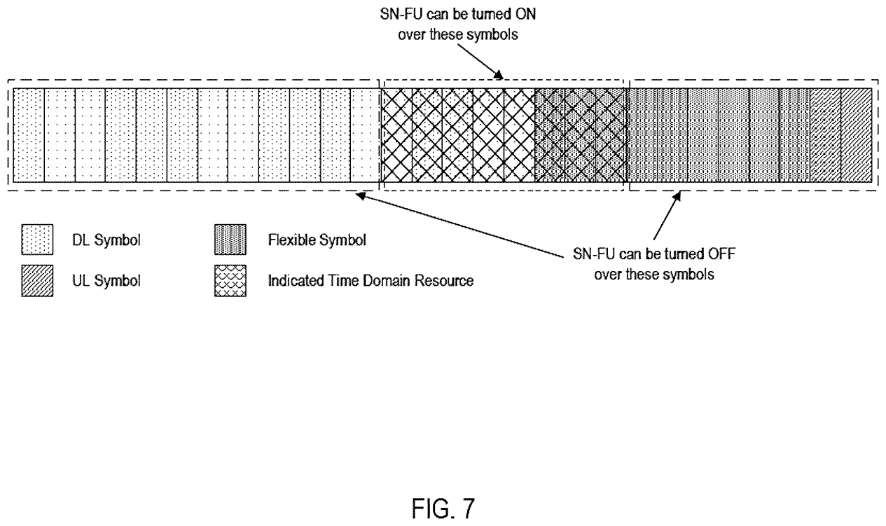

Opt 1-6 (option 1-6): For the flexible symbols based on the semi-static configuration and/or dynamic UL-DL indication that are not in an indicated time domain resource(s), the SN-FU can be expected to be OFF or not forwarding over these symbols. In other words, in Opt 1-6, for the symbols in an indicated time domain resource(s), regardless of whether the symbols are flexible symbols or not, the SN-FU can be expected to be ON or forwarding over these symbols. For other symbols, the SN-FU can be expected to be OFF or not forwarding in the indicated time domain resource(s). FIG. 7 illustrates an example method for controlling a smart node ON/OFF state (e.g., Opt 1-6), in accordance with some embodiments of the present disclosure.

Further, one or more of the following points can be performed in Opt 1-6.
The indicated time domain resource(s) can be associated with corresponding beam(s) in the forwarding link beam indication.
The forwarding link beam indication can be indicated to SN (SN-CU) by the base station for SN (SN-FU) forwarding.
The forwarding link beam indication can be access link beam indication and/or backhaul link beam indication.
The forwarding link beam indication may include beam information (e.g. beam index(es)) and/or the corresponding time domain resource(s).
The indicated time domain resource(s) and/or beam index(es) in the beam indication can be valid.

Opt 1-7: If an indicated time domain resource(s) overlap with/include the flexible symbols based on the semi-static configuration and/or dynamic UL-DL indication, for these overlapped flexible symbols, at least one of following options can be considered.

Opt 1-7-1: The SN-FU can be expected to be OFF or not forwarding, as same as Opt 1-5. That means/indicates the priority of the default behavior of the SN-FU is higher than the priority of the ON indication via the forwarding link beam indication.

Opt 1-7-2: The SN-FU can be expected to be ON or forwarding, as same as Opt 1-6. That means/indicates the priority of the default behavior of the SN-FU is lower than the priority of the ON indication via the forwarding link beam indication.

Opt 1-7-3: The SN-FU can be expected to be ON or forwarding if the forwarding link beam indication is one or more types of the following indications.
Periodic and/or semi-persistent beam indication(s) with a priority flag (the flag presents or the flag=1).
Periodic and/or semi-persistent beam indication(s) with a priority flag. In addition, time domain resource(s) and/or beam index(es) in the beam indication(s) can be valid.
Aperiodic beam indication(s).
Aperiodic beam indication(s). In addition, time domain resource(s) and/or beam index(es) in the beam indication(s) can be valid.
Periodic and/or semi-persistent beam indication(s) (without priority flag or the flag=0).
Periodic and/or semi-persistent beam indication(s). In addition, time domain resource(s) and/or beam index(es) in the beam indication(s) can be valid.

The indicated time domain resource(s) can be associated with corresponding beam(s) in the forwarding link beam indication. The definition/operation of forwarding link beam indication can refer to the points in above options and may not be repeated here. Periodic/semi-persistent/aperiodic beam indication can be indication(s) sent by the base station to SN (SN-CU) for indicating beam index and/or time resource for forwarding links (e.g., access links). In addition, periodic beam indication can be carried by RRC signaling, semi-persistent indication can be carried by RRC signaling and/or MAC CE, and aperiodic beam indication can be carried by RRC signaling, DCI signaling and/or MAC CE. The SN-FU can be expected to be OFF or not forwarding if the forwarding link beam indication is other types.

In Opt 1-7-3, the priority of some types of beam indication for indicating ON can be higher than the priority of the default behavior of the SN-FU, while the priority of other types can be lower than the priority of the default behavior of the SN-FU.

### IMPLEMENTATION EXAMPLE 2

In time division duplex (TDD) configurations, a time unit (e.g., symbols, slots, or subframes) can be semi-statically or dynamically configured with DL, UL, and/or flexible direction. The time unit can be called a DL time unit, a UL time unit, or a flexible time unit. A half-duplex device can transmit or receive in one direction during this time unit. Even for the flexible time unit, if a base station (or a UE) performs transmission at the flexible time unit, the BS (or UE) cannot simultaneously perform reception operations, and vice versa.

In the full duplex mode or FDM operation mode, some or all of the frequency domain resources in corresponding carrier(s)/band(s) over a time unit can be configured as a subband (SB). SB can be defined as a set of continuous or discontinuous frequency resources (e.g. resource blocks or resource elements), and thus may be equivalent to concepts such as resource block set, resource block group, channel, sub-channel, carrier, carrier group, passband, frequency band, frequency resource, frequency range, operating band, cell, and/or bandwidth part.

For example, in the full duplex mode, some or all of the frequency domain resources in a carrier over the above DL/flexible time unit can be reconfigured as UL SB (and/or full duplex SB, flexible SB, guard SB), or some or all of the frequency domain resources in the carrier of the above UL/flexible time unit can be reconfigured as DL SB (and/or full duplex SB, flexible SB, guard SB) to support full duplex operations. These time units with SB can also be referred to as SB time units (e.g., SB symbols, SB slots). In a SB time unit, there may be one or more SBs in a carrier.

For the sake of distinction, time units without configuring SB can be referred to as non-SB time units or as normal time units (e.g., a flexible symbol can be a non-SB flexible symbol (e.g., normal flexible symbol) or a SB flexible symbol. In present disclosure, for convenience of description, “symbol” can be used as an example of “time unit”.

In the following, several options are provided/considered to solve issues of how to determine the ON/OFF behavior of SN-FU.

Opt 2-1 (option 2-1): A default behavior of the SN-FU can be expected to be OFF or not forwarding in the 4th time/frequency (“/” represents “and/or”) domain resource(s) based on a semi-static configuration (e.g., TDD-UL-DL-ConfigCommon, and/or TDD-UL-DL-ConfigDedicated) and/or dynamic configuration (e.g., a SFI signaling, a new dynamic signaling or a scheduling signaling with explicit/implicit indication), if 4th time/frequency domain resource(s) is at least one of the following.
The symbols can be normal flexible symbols (or non-SB flexible symbols, or flexible symbols without configuring SB), SB flexible symbols.
The symbols can be flexible symbols (either SB flexible symbols or normal flexible symbols).
The time/frequency domain resources(s) over flexible symbols other than the resource(s) of SB.

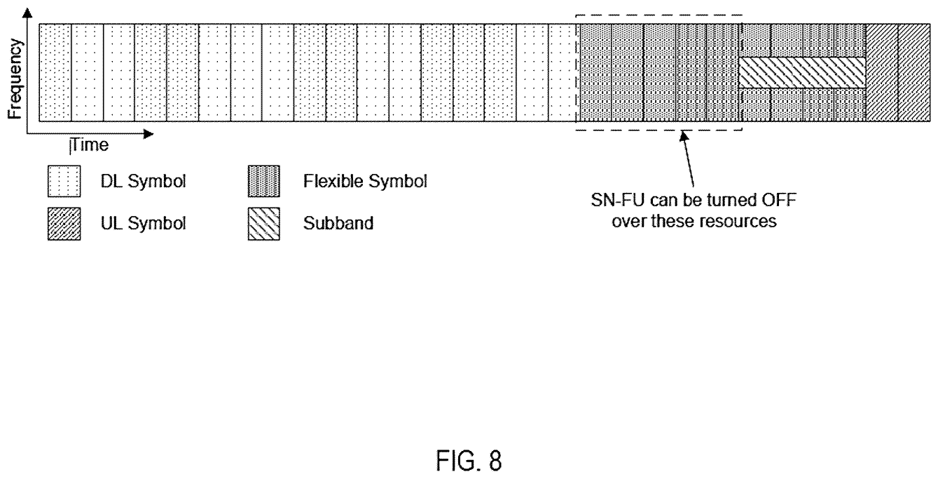

For example, 4th time/frequency domain resource can be: the symbols can be normal flexible symbols, and the frequency resource may have no restriction (e.g., the frequency resource can be a carrier). SN-FU can be expected to be OFF or not forwarding in above 4th time/frequency domain resource, as shown in FIG. 8. FIG. 8 illustrates an example method for controlling a smart node ON/OFF state (e.g., Opt 2-1), in accordance with some embodiments of the present disclosure.

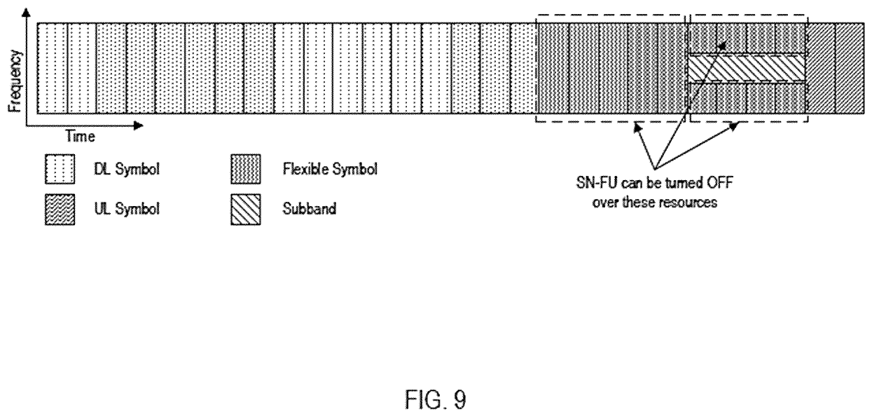

For another example, 4th time/frequency domain resource can be: the time/frequency domain resources(s) over flexible symbols other than the resource(s) of SB, the symbols can be flexible symbols (either SB flexible symbols or normal flexible symbols), and/or the frequency resource can be the resource other than SB. SN-FU can be expected to be OFF or not forwarding in above 4th time/frequency domain resource, as shown in FIG. 9. FIG. 9 illustrates an example method for controlling a smart node ON/OFF state (e.g., Opt 2-1), in accordance with some embodiments of the present disclosure.

In other words, SN-FU may forward, transmit and/or receive (e.g., turning SN-FU ON) only in the time/frequency domain resource(s) other than 4th time/frequency domain resource(s), namely 1st time/frequency domain resource(s). The 1st time/frequency domain resource(s) can also be configured based on a semi-static configuration (e.g., TDD-UL-DL-ConfigCommon, and/or TDD-UL-DL-ConfigDedicated) and/or dynamic configuration (e.g., a SFI signaling, a new dynamic signaling or a scheduling signaling with explicit/implicit indication). The 1st time/frequency domain resource(s) can be at least one of the following: the symbols are DL symbols, UL symbols, or SB flexible symbols; or the time/frequency domain resources(s) of SB over flexible symbols.

For example, SN-FU may receive on the backhaul link or transmit on the access link only in the DL symbols, SB symbols (e.g., flexible symbols with SB, UL symbols with SB), and/or the time/frequency domain resources(s) of SB over flexible/UL symbols. Here a SB can refer to a DL SB.

For another example, SN-FU may receive on the access link or transmit on the backhaul link only in the UL symbols, SB symbols (e.g., flexible symbols with SB, DL symbols with SB), and/or the time/frequency domain resources(s) of SB over flexible/DL symbols. Here a SB can refer to a UL SB.

The SN-FU can be expected to be OFF or not forwarding in a carrier if the carrier is indicated to be as OFF or inactive or not forwarding by the base station, and/or if TDD configuration of the carrier is not indicated to the SN (SN-CU) by the base station (e.g., SN does not receive the TDD configuration of the carrier from the base station or OAM), and the TDD configuration includes semi-static configuration (e.g., TDD-UL-DL-ConfigCommon, and/or TDD-UL-DL-ConfigDedicated), and/or dynamic configuration (e.g., SFI, a new dynamic signaling or a scheduling signaling with explicit/implicit indication). Carrier may also refer to subband, passband, cell, frequency band, frequency resource, etc., similar to the definition of subband. In other words, the SN-FU can be expected to be ON or forwarding in a carrier only if the carrier is indicated to be as ON or active or forwarding by the base station, and/or only if TDD configuration of the carrier is indicated to the SN (SN-CU) by the base station.

Opt 2-2 (option 2-2): The SN-FU can be expected to be ON or forwarding over an indicated 2nd time/frequency domain resource(s). The indicated 2nd time/frequency domain resource(s) can be at least one of the following.
The indicated 2nd time domain resource(s) is associated with corresponding beam(s) in the forwarding link beam indication.
The indicated 2nd frequency domain resource(s) is associated with corresponding beam(s) in the forwarding link beam indication.
The forwarding link beam indication is indicated to SN (SN-CU) by the base station for SN (SN-FU) forwarding.
The forwarding link beam indication can be access link beam indication and/or backhaul link beam indication.
The forwarding link beam indication includes beam information (e.g., beam index(es)) and/or the corresponding 2nd time/frequency domain resource(s).
The indicated 2nd time/frequency domain resource(s) and/or beam index(es) in the beam indication is valid.

In other words, the SN-FU may transmit or receive only in the indicated 2nd time/frequency domain resource(s). In other words, the SN-FU can be expected to be OFF or not forwarding over the resources beyond the indicated 2nd time/frequency domain resource(s). The resources beyond the indicated 2nd time/frequency domain resource(s) is the 5th time/frequency domain resource(s).

Further, the SN-FU can be expected to be ON or forwarding (only) over an indicated 2nd time/frequency domain resource(s) in a carrier. For other carriers, the SN-FU can be expected to be OFF or not forwarding, if no 2nd time/frequency domain resource(s) in these carriers are indicated. Carrier also refer to subband, passband, cell, frequency band, frequency resource, etc., similar to the definition of subband.

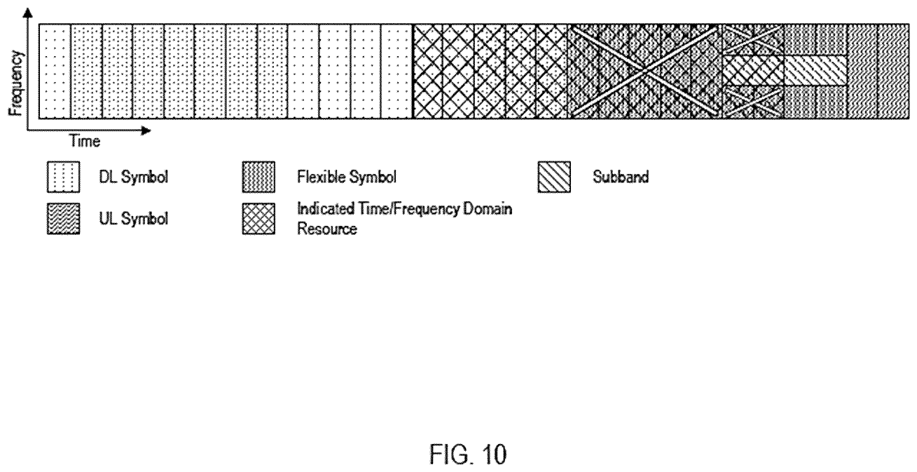

Opt 2-3 (option 2-3): An indicated 2nd time/frequency domain resource(s) can not overlap with/include 4th time/frequency domain resource(s), or the second T/F resources may belong to the first T/F resources. The definition of 4th time/frequency domain resource(s) can be given in Opt 2-1. FIG. 10 illustrates an example method for controlling a smart node ON/OFF state (e.g., Opt 2-3), in accordance with some embodiments of the present disclosure.

For example, an indicated 2nd time domain resource(s) can not overlap with/include normal flexible symbols (or non-SB flexible symbols without configuring SB), or flexible symbols (either SB flexible symbols or normal flexible symbols). An indicated 2nd frequency domain resource(s) can not overlap with/include resource(s) other than SB in flexible symbols. The definition of (normal) flexible symbols can refer to above description in this disclosure.

Further, one or more of the following points can be performed/considered in Opt 2-3.
The indicated 2nd time domain resource(s) can be associated with corresponding beam(s) in the forwarding link beam indication.
The indicated 2nd frequency domain resource(s) can be associated with corresponding beam(s) in the forwarding link beam indication.
The forwarding link beam indication can be indicated to SN (SN-CU) by the base station for SN (SN-FU) forwarding.
The forwarding link beam indication can be access link beam indication and/or backhaul link beam indication.
The forwarding link beam indication may include beam information (e.g., beam index(es)) and/or the corresponding 2nd time/frequency domain resource(s).
The indicated 2nd time/frequency domain resource(s) and/or beam index(es) in the beam indication can be valid.

In other words, the SN (SN-CU/FU) may not be expected that the indicated 2nd time domain resource(s) overlap with/include normal flexible symbols or flexible symbols. The SN (SN-CU/FU) may not be expected that the indicated 2nd frequency domain resource(s) overlap with/include resource(s) other than SB in flexible symbols.

Correspondingly, the base station can not configure/indicate the 2nd time domain resource(s) that overlap with/include normal flexible symbols or flexible symbols. The base station can not configure/indicate the 2nd frequency domain resource(s) that overlap with/include resource(s) other than SB in flexible symbols.

In other words, with the restrictions of Opt 2-3, for the indicated 2nd time/frequency domain resource(s), the SN-FU can be expected to be ON or forwarding over these resources. For other time/frequency domain resource(s), the SN-FU can be expected to be OFF or not forwarding.

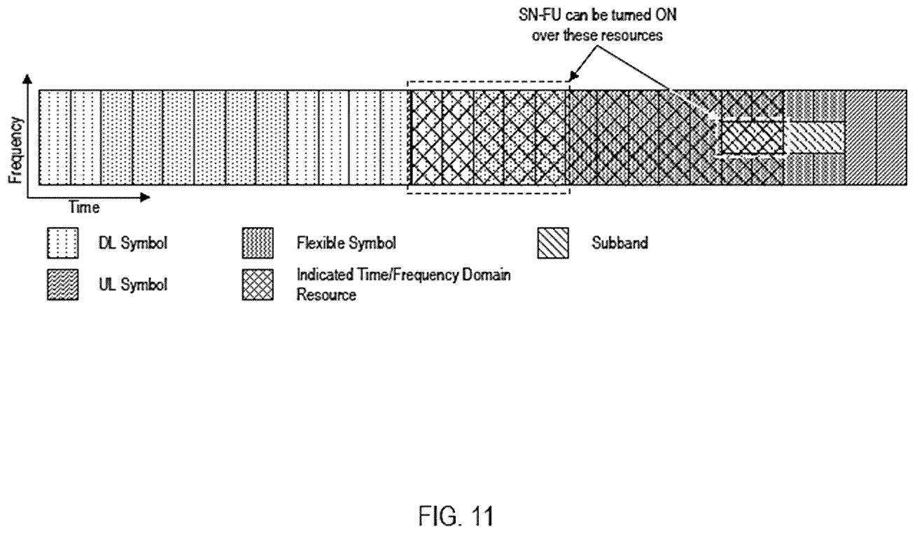

Opt 2-4 (option 2-4): For the resources that are in an indicated 2nd time/frequency domain resource(s) and not in 4th time/frequency domain resource(s), the SN-FU can be expected to be ON or forwarding over these resources. The definition of 4th time/frequency domain resources can be given in Opt 2-1. FIG. 11 illustrates an example method for controlling a smart node ON/OFF state (e.g., Opt 2-4), in accordance with some embodiments of the present disclosure.

Further, one or more of the following points can be performed/considered in Opt 2-4.
The indicated 2nd time domain resource(s) can be associated with corresponding beam(s) in the forwarding link beam indication.
The indicated 2nd frequency domain resource(s) can be associated with corresponding beam(s) in the forwarding link beam indication.
The forwarding link beam indication can be indicated to SN (SN-CU) by the base station for SN (SN-FU) forwarding.
The forwarding link beam indication can be access link beam indication and/or backhaul link beam indication.
The forwarding link beam indication may include beam information (e.g. beam index(es)) and/or the corresponding 2nd time/frequency domain resource(s).
The indicated 2nd time/frequency domain resource(s) and/or beam index(es) in the beam indication can be valid.
The SN-FU can be expected to be OFF or not forwarding in other resources (e.g., in the resources that are in the indicated 2nd time/frequency domain resource(s) and in 4th time/frequency domain resource(s)).
In the resources that are not in the indicated 2nd time/frequency domain resource(s).

In Opt 2-4, for the resources in 4th time/frequency domain resource(s), regardless of whether the resources are in the indicated 2nd time domain resource(s) or not, the SN-FU can be expected to be OFF or not forwarding over these resources.

Opt 2-5 (option 2-5): For the resources in 4th time/frequency domain resource(s) but not in an indicated 2nd time/frequency domain resource(s), the SN-FU can be expected to be OFF or not forwarding over these resources.

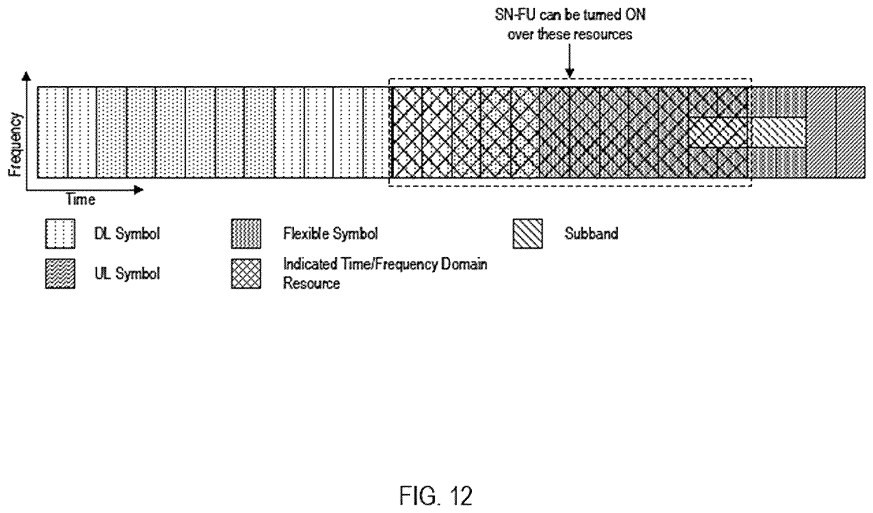

In other words, in Opt 2-5, for the resources in an indicated 2nd time/frequency domain resource(s), regardless of whether the resources are in 4th time/frequency domain resource(s) or not, the SN-FU can be expected to be ON or forwarding over these resources. For other resources, the SN-FU can be expected to be OFF or not forwarding. FIG. 12 illustrates an example method for controlling a smart node ON/OFF state (e.g., Opt 2-4), in accordance with some embodiments of the present disclosure.

Further, one or more of the following points can be performed/considered in Opt 2-5.
The indicated 2nd time domain resource(s) can be associated with corresponding beam(s) in the forwarding link beam indication.
The indicated 2nd frequency domain resource(s) can be associated with corresponding beam(s) in the forwarding link beam indication.
The forwarding link beam indication can be indicated to SN (SN-CU) by the base station for SN (SN-FU) forwarding.
The forwarding link beam indication can be access link beam indication and/or backhaul link beam indication.
The forwarding link beam indication may include beam information (e.g. beam index(es)) and/or the corresponding 2nd time/frequency domain resource(s).
The indicated 2nd time/frequency domain resource(s) and/or beam index(es) in the beam indication can be valid.

Opt 2-6 (option 2-6): If an indicated 2nd time/frequency domain resource(s) overlap with/include 4th time/frequency domain resource(s), for these overlapped resources (3^{rd} time/frequency domain resource(s)), at least one of following options can be considered.

Opt 2-6-1 (option 2-6-1): The SN-FU can be expected to be OFF or not forwarding, as same as Opt 2-4. That means/indicates the priority of the default behavior of the SN-FU can be higher than the priority of the ON indication via the forwarding link beam indication.

Opt 2-6-2 (option 2-6-2): The SN-FU can be expected to be ON or forwarding, as same as Opt 2-5. That means/indicates the priority of the default behavior of the SN-FU can be lower than the priority of the ON indication via the forwarding link beam indication.

Opt 2-6-3 (option 2-6-3): The SN-FU can be expected to be ON or forwarding if the forwarding link beam indication is one or more types of the following indications.
Periodic and/or semi-persistent beam indication(s) with a priority flag (the flag presents or the flag=1).
Periodic and/or semi-persistent beam indication(s) with a priority flag. In addition, time domain resource(s) and/or beam index(es) in the beam indication(s) can be valid.
Aperiodic beam indication(s).
Aperiodic beam indication(s). In addition, time domain resource(s) and/or beam index(es) in the beam indication(s) can be valid.
Periodic and/or semi-persistent beam indication(s) (without priority flag or the flag=0).
Periodic and/or semi-persistent beam indication(s). In addition, time domain resource(s) and/or beam index(es) in the beam indication(s) can be valid.

The indicated 2nd time/frequency domain resource(s) can be associated with corresponding beam(s) in the forwarding link beam indication. The definition/operation of (periodic/semi-persistent/aperiodic) forwarding link beam indication can refer to above embodiments/options and may not be repeated here. The SN-FU can be expected to be OFF or not forwarding if the forwarding link beam indication is other types.

It should be understood that one or more features from the above implementation examples are not exclusive to the specific implementation examples, but can be combined in any manner (e.g., in any priority and/or order, concurrently or otherwise).

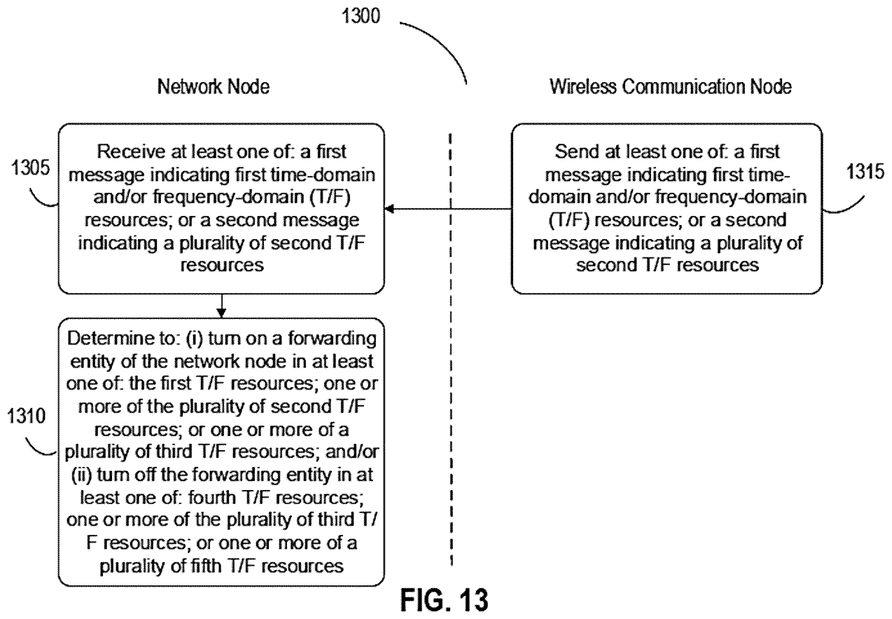

FIG. 13 illustrates a flow diagram of a method 1300 for controlling a smart node ON/OFF state. The method 1300 may be implemented using any one or more of the components and devices detailed herein in conjunction with FIGS. 1-2. In overview, the method 1300 may be performed by a network node, in some embodiments. Additional, fewer, or different operations may be performed in the method 1300 depending on the embodiment. At least one aspect of the operations is directed to a system, method, apparatus, or a computer-readable medium.

A network node (e.g., smart node (SN)) may receive, from a wireless communication node (e.g., base station (BS) or gNB), at least one of: a first message indicating first time-domain and/or frequency-domain (T/F) resources; or a second message indicating a plurality of second T/F resources. The network node may determine to: (i) turn on a forwarding entity of the network node in at least one of: the first T/F resources; one or more of the plurality of second T/F resources; or one or more of a plurality of third T/F resources; and/or (ii) turn off the forwarding entity in at least one of: fourth T/F resources; one or more of the plurality of third T/F resources; or one or more of a plurality of fifth T/F resources. The third T/F resources can be determined based on the first T/F resources, the second T/F resources, and/or the fourth T/F resources. The fourth T/F resources can be determined based on the first T/F resources, or indicated via the first message. The fifth T/F resources can be determined based on the second T/F resources.

In some embodiments, the step of turning on the forwarding entity may further comprise causing the forwarding entity to forward, transmit, and/or receive only in the first T/F resources, only in the one or more second T/F resources, and/or only in the one or more third T/F resources. The first T/F resources may include at least one of: a. DL time units; b. UL time units; c. flexible time units; d. time units with frequency bands in a frequency domain; c. DL time units with frequency bands in a frequency domain; f. UL time units with frequency bands in a frequency domain; g. flexible time units with frequency bands in a frequency domain; h. time units without frequency bands in a frequency domain; i. DL time units without frequency bands in a frequency domain; j. UL time units without frequency bands in a frequency domain; k. flexible time units without frequency bands in a frequency domain; l. frequency bands; m. frequency bands in DL time units; n. frequency bands in UL time units; o. frequency bands in flexible time units; p. T/F resources outside of frequency bands; q. T/F resources outside of frequency bands in DL time units; r. T/F resources outside of frequency bands in UL time units; or s. T/F resources outside of frequency bands in flexible time units. The second T/F resources can be configured for the forwarding entity to forward, transmit and/or receive. The second T/F resources can be associated with beams indicated in the second message. The second T/F resources and/or the beams can be valid.

In some embodiments, the step of turning off the forwarding entity may further comprise causing the forwarding entity not to forward, transmit and/or receive in the fourth T/F resources, in the one or more third T/F resources, and/or in the one or more fifth T/F resources. The fourth T/F resources may include resources beyond the first T/F resources, or at least one of: a. DL time units; b. UL time units; c. flexible time units; d. time units with frequency bands in a frequency domain; c. DL time units with frequency bands in a frequency domain; f. UL time units with frequency bands in a frequency domain; g. flexible time units with frequency bands in a frequency domain; h. time units without frequency bands in a frequency domain; i. DL time units without frequency bands in a frequency domain; j. UL time units without frequency bands in a frequency domain; k. flexible time units without frequency bands in a frequency domain; l. frequency bands; m. frequency bands in DL time units; n. frequency bands in UL time units; o. frequency bands in flexible time units; p. T/F resources outside of frequency bands; q. T/F resources outside of frequency bands in DL time units; r. T/F resources outside of frequency bands in UL time units; or s. T/F resources outside of frequency bands in flexible time units.

In some embodiments, the fifth T/F resources may include resources beyond the second T/F resources. The second T/F resources may not overlap with or may not include the fourth T/F resources, or the second T/F resources may belong to the first T/F resources. The third T/F resources may include resources that overlap between the fourth T/F resources and the second T/F resources, or resources that are in the second T/F resources but are not in the first T/F resources, or resources that are in the first T/F resources but are not in the second T/F resources.

In some embodiments, the network node may receive, from the wireless communication node, the second message including an indication for the forwarding entity to transmit and/or receive. The network node may determine to turn on the forwarding unit in the third T/F resources if the indication meets at least one of: (a) the indication being periodic; (b) the indication being semi-persistent; (c) the indication being aperiodic; (d) the indication with a priority flag; or (c) time-domain resource(s) and/or beam index(es) in the indication being valid. The network node may determine to turn off the forwarding unit, in response to the indication of the second message does not meet any of the conditions (a) to (e). The time unit can be a symbol, a slot, a subframe, or a frame. The frequency band may include at least one of: a subband, a set of resource block, a group of resource block, a channel, a sub-channel, a carrier, a carrier group, a passband, a frequency resource, a frequency range, an operating band, a cell, a bandwidth part, or a band of frequency spectrum. The frequency band can be a frequency band with DL or UL direction, an active or inactive frequency band, or a frequency band whose TDD configuration is indicated or not indicated to the network node. The first message and/or the second message can include at least one of: one or more system information, one or more a RRC signalings, one or more a MAC CEs, one or more DCI signalings, or a combination thereof.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A wireless communication method, comprising:
receiving, by a network node from a wireless communication node, at least one of: a first message indicating first time-domain and/or frequency-domain (T/F) resources; or a second message indicating a plurality of second T/F resources; and
determining, by the network node, to:
(i) turn on a forwarding entity of the network node in at least one of: the first T/F resources; one or more of the plurality of second T/F resources; or one or more of a plurality of third T/F resources; and/or
(ii) turn off the forwarding entity in at least one of: fourth T/F resources; one or more of the plurality of third T/F resources; or one or more of a plurality of fifth T/F resources,
wherein the third T/F resources are determined based on the first T/F resources, the second T/F resources, and/or the fourth T/F resources,
wherein the fourth T/F resources are determined based on the first T/F resources, or indicated via the first message,
wherein the fifth T/F resources are determined based on the second T/F resources.

2. The wireless communication method of claim 1, wherein the step of turning on the forwarding entity further comprises causing the forwarding entity to forward, transmit, and/or receive only in the first T/F resources, only in the one or more second T/F resources, and/or only in the one or more third T/F resources.

3. The wireless communication method of claim 1, wherein the first T/F resources include at least one of:
a. DL time units;
b. UL time units;
c. flexible time units;
d. time units with frequency bands in a frequency domain;
e. DL time units with frequency bands in a frequency domain;
f. UL time units with frequency bands in a frequency domain;
g. flexible time units with frequency bands in a frequency domain;
h. time units without frequency bands in a frequency domain;
i. DL time units without frequency bands in a frequency domain;
j. UL time units without frequency bands in a frequency domain;
k. flexible time units without frequency bands in a frequency domain;
l. frequency bands;
m. frequency bands in DL time units;
n. frequency bands in UL time units;
o. frequency bands in flexible time units;
p. T/F resources outside of frequency bands;
q. T/F resources outside of frequency bands in DL time units;
r. T/F resources outside of frequency bands in UL time units; or
s. T/F resources outside of frequency bands in flexible time units.

4. The wireless communication method of claim 1, wherein the second T/F resources are configured for the forwarding entity to forward, transmit and/or receive.

5. The wireless communication method of claim 4, wherein the second T/F resources are associated with beams indicated in the second message.

6. The wireless communication method of claim 5, wherein the second T/F resources and/or the beams are valid.

7. The wireless communication method of claim 1, wherein the step of turning off the forwarding entity further comprises causing the forwarding entity not to forward, transmit and/or receive in the fourth T/F resources, in the one or more third T/F resources, and/or in the one or more fifth T/F resources.

8. The wireless communication method of claim 1, wherein the fourth T/F resources include resources beyond the first T/F resources, or at least one of:
a. DL time units;
b. UL time units;
c. flexible time units;
d. time units with frequency bands in a frequency domain;
e. DL time units with frequency bands in a frequency domain;
f. UL time units with frequency bands in a frequency domain;
g. flexible time units with frequency bands in a frequency domain;
h. time units without frequency bands in a frequency domain;
i. DL time units without frequency bands in a frequency domain;
j. UL time units without frequency bands in a frequency domain;
k. flexible time units without frequency bands in a frequency domain;
l. frequency bands;
m. frequency bands in DL time units;
n. frequency bands in UL time units;
o. frequency bands in flexible time units;
p. T/F resources outside of frequency bands;
q. T/F resources outside of frequency bands in DL time units;
r. T/F resources outside of frequency bands in UL time units; or
s. T/F resources outside of frequency bands in flexible time units.

9. The wireless communication method of claim 1, wherein the fifth T/F resources include resources beyond the second T/F resources.

10. The wireless communication method of claim 1, wherein the second T/F resources should not overlap with or should not include the fourth T/F resources, or the second T/F resources should belong to the first T/F resources.

11. The wireless communication method of claim 1, wherein the third T/F resources include resources that overlap between the fourth T/F resources and the second T/F resources, or resources that are in the second T/F resources but are not in the first T/F resources, or resources that are in the first T/F resources but are not in the second T/F resources.

12. The wireless communication method of claim 1, further comprising:
receiving, by the network node from the wireless communication node, the second message including an indication for the forwarding entity to transmit and/or receive; and
determining, by the network node, to turn on the forwarding unit in the third T/F resources if the indication meets at least one of:
(a) the indication being periodic;
(b) the indication being semi-persistent;
(c) the indication being aperiodic;
(d) the indication with a priority flag; or
(e) time-domain resource(s) and/or beam index(es) in the indication being valid.

13. The wireless communication method of claim 12, further comprising determining, by the network node, to turn off the forwarding unit, in response to the indication of the second message does not meet any of the conditions (a) to (e).

14. The wireless communication method of claim 3, wherein the time unit can be a symbol, a slot, a subframe, or a frame.

15. The wireless communication method of claim 3, wherein the frequency band includes at least one of: a subband, a set of resource block, a group of resource block, a channel, a sub-channel, a carrier, a carrier group, a passband, a frequency resource, a frequency range, an operating band, a cell, a bandwidth part, or a band of frequency spectrum.

16. The wireless communication method of claim 3, wherein the frequency band is a frequency band with DL or UL direction, an active or inactive frequency band, or a frequency band whose TDD configuration is indicated or not indicated to the network node.

17. The wireless communication method of claim 1, wherein the first message and/or the second message can include at least one of: one ore more system information, one or more RRC signalings, one or more MAC CEs, one or more DCI signalings, or a combination thereof.

18. A network node, comprising:
at least one processor configured to:
receive, via a receiver from a wireless communication node, at least one of: a first message indicating first time-domain and/or frequency-domain (T/F) resources; or a second message indicating a plurality of second T/F resources; and
determine to:
(i) turn on a forwarding entity of the network node in at least one of: the first T/F resources; one or more of the plurality of second T/F resources; or one or more of a plurality of third T/F resources; and/or
(ii) turn off the forwarding entity in at least one of: fourth T/F resources; one or more of the plurality of third T/F resources; or one or more of a plurality of fifth T/F resources,
wherein the third T/F resources are determined based on the first T/F resources, the second T/F resources, and/or the fourth T/F resources,
wherein the fourth T/F resources are determined based on the first T/F resources, or indicated via the first message,
wherein the fifth T/F resources are determined based on the second T/F resources.

19. A wireless communication method, comprising:
transmitting, by a wireless communication node to a network node, at least one of: a first message indicating first time-domain and/or frequency-domain (T/F) resources; or a second message indicating a plurality of second T/F resources; and
causing the network node to determine to:
(i) turn on a forwarding entity of the network node in at least one of: the first T/F resources; one or more of the plurality of second T/F resources; or one or more of a plurality of third T/F resources; and/or
(ii) turn off the forwarding entity in at least one of: fourth T/F resources; one or more of the plurality of third T/F resources; or one or more of a plurality of fifth T/F resources,
wherein the third T/F resources are determined based on the first T/F resources, the second T/F resources, and/or the fourth T/F resources,
wherein the fourth T/F resources are determined based on the first T/F resources, or indicated via the first message,
wherein the fifth T/F resources are determined based on the second T/F resources.

20. A wireless communication node, comprising:
at least one processor configured to:
transmit, via a transmitter to a network node, at least one of: a first message indicating first time-domain and/or frequency-domain (T/F) resources; or a second message indicating a plurality of second T/F resources; and
cause the network node to determine to:
(i) turn on a forwarding entity of the network node in at least one of: the first T/F resources; one or more of the plurality of second T/F resources; or one or more of a plurality of third T/F resources; and/or
(ii) turn off the forwarding entity in at least one of: fourth T/F resources; one or more of the plurality of third T/F resources; or one or more of a plurality of fifth T/F resources,
wherein the third T/F resources are determined based on the first T/F resources, the second T/F resources, and/or the fourth T/F resources,
wherein the fourth T/F resources are determined based on the first T/F resources, or indicated via the first message,
wherein the fifth T/F resources are determined based on the second T/F resources.
